(19) United States
(12) Patent Application Publication
(10) Pub. No.: US 2005/0219210 A1
(43) Pub. Date: Oct. 6, 2005

(54) Pointer interface for handheld devices

(75) Inventors: Danny Leland, Coquitlam (CA); Steven George Mason, Vancouver (CA); Harry Bow Sing Lew, Vancouver (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(73) Assignee: THE NEIL SQUIRE SOCIETY

(21) Appl. No.: 11/072,254

(22) Filed: Mar. 7, 2005

Related U.S. Application Data
(60) Provisional application No. 60/558,656, filed on Mar. 31, 2004.

(51) Int. Cl. G09G 5/08

(52) U.S. Cl. 345/157

(57) ABSTRACT

An interface for a handheld computing device to interact with a peripheral pointing device uses of a pointer tracking memory in the handheld computer to track the position of a pointer. The pointer tracking memory is updated when the peripheral pointing device sends an X-Y offset signal. The interface paints a pointer on the handheld device touchscreen at a location determined by the pointer tracking memory. When a button click signal is received from the peripheral pointing device, a touchscreen tap is simulated at the location stored in the pointer tracking memory. The touchscreen tap simulation is passed to the operating system routines that normally handle taps. The operating system then processes the simulated tap as it would a physical tap. This provides compatibility with all existing legacy applications.

### CROSS REFERENCE TO RELATED APPLICATIONS

This application claims the benefit of U.S. Provisional Application No. 60/558,656 filed Mar. 31, 2004, which is incorporated herein by reference.

### FIELD OF THE INVENTION

The present invention relates generally to alternate pointing interfaces for limited form factor computing platforms. More particularly, the present invention relates to the creation of an interface for limited form factor computing platforms to allow the use of external pointing devices to enable disabled users to use these computing platforms.

### BACKGROUND OF THE INVENTION

Handheld devices, such as those utilizing the Palm OS or Windows for Pocket PC, allow limited form factor devices to provide applications to users.

To accommodate the limited form factor, external pointing devices such as mice and track pads are obviated through the use of a touch screen display. As opposed to a standard graphical user interface, in which a mouse pointer freely roams a screen, no on-screen pointer is utilized. A user taps on a screen, preferably using a stylus, to both make selections and to activate menus.

To allow for single-handed use of these devices, many devices employ embedded alternate inputs such as rocker switches and jog dials. These devices interact with modified operating systems to move a selection indicator. Thus, users can scroll through lists of applications to highlight a desired application, and then depress the rocker switch or jog dial to make a selection.

The alternate input, however, cannot be used in all applications, as its functionality is enabled by modifications to the otherwise standard operating system. Thus, two different device manufacturers can implement the alternate pointing device and operating system modifications in different ways. As a result, software vendors either support a single proprietary implementation or provide no such support.

At its most basic, a touchscreen provides an interface supported by the operating system. As such, any application can rely upon a standard interface to the touchscreen. As alternate pointing devices are not supported by the underlying unmodified operating system, applications cannot rely upon a standardized interface for alternate pointing devices across a variety of platforms. As a result, applications do not typically provide support for a number of alternative pointing devices.

The standardization of alternate pointing device interfaces meets a number of different obstacles. Pointing devices are typically integrated to the handheld device and as such are implemented by the device manufacturer who has the ability to modify the operating system. There is little incentive for competing designers to create a standardized interface across platforms, as each device hardware manufacturer supplies both the hardware platform and the modified operating system. By co-operating with other vendors, the manufacturer may lose a competitive advantage in the implementation of the pointing device.

Pointing devices for limited form factor devices are typically designed as integrated components. The lack of a standardized interface results in very few applications supporting alternate pointing device, while the dearth of applications limits the number of parties interested in manufacturing peripheral pointing devices.

The lack of peripheral or alternate pointing devices, either offered by device manufacturers or by third parties has a significant drawback for several communities. People for whom fine or gross motor control is impaired are unable to use these computing devices. The small size of the device lends itself to mobile solutions that are suitable for physically disabled individuals if the problems associated with the pointing and input devices are addressed.

Disabled individuals can often employ a centrally located control system for environmental control in their homes. These systems have historically required customized control circuitry to allow for control of elements such as blinds, lights, climate control and entertainment systems. With the advent of consumer home automation systems based on standardized components, a low cost home automation system can be implemented with a single terminal control system.

Despite these advances disabled individuals are limited to accessing and controlling these systems from a non-mobile computer, because of the lack of accessible pointing devices for mobile computing platforms.

Laptops can be used to control home automation systems, they are not ideal for this task. Laptop computers have high costs. They also consume large quantities of power resulting in a requirement to either provide a supplementary power source or to frequently recharge. As a side effect of the power consumption, laptop computers also generate large quantities of heat. The heat must be properly dissipated to avoid shortening the lifespan of the laptop and to avoid physically harming the users. Disabled users may not be able to accurately judge whether or not heat generated by a laptop is causing injury to a limb that they may not have sensation in.

An able-bodied individual has access to home automation control from handheld computing platforms. This feature is typically unavailable to physically disabled individuals who lack either fine or gross motor control, as the manipulation of a touch screen using a stylus requires a high degree of manual dexterity. The improvement in the standard of living offered by portable control of home automation to a disabled person is far greater than the improvement provided to an able bodied individual; and the greatest impediment for a disabled person to access limited form factor computing devices is the inability to use an alternate pointing device with presently available hand held computing device applications.

By enabling alternate pointing devices to fully interact with handheld device operating systems and the existing base of applications, disabled individuals can make use of handheld devices for automation control and other tasks. Alternate pointing devices can address the different challenges faced by various individuals. Trackballs can be used by individuals that lack fine motor control, while other devices, such as a joystick based mouse like the Jouse designed by the Neil Squire Society of Vancouver British Columbia, can be used by individuals without the ability to manually manipulate even a trackball.

Thus, it would be advantageous to provide a mechanism to enable alternate pointing devices for limited form factor computing platforms, while supporting existing applications and not requiring revision of the application to support the new device.

### SUMMARY OF THE INVENTION

It is an object of the present invention to obviate or mitigate at least one disadvantage of previous limited form factor pointing device interfaces. It is a further object of the present invention to provide an interface between a pointing device and a limited form factor computing device that is transparent to existing and legacy applications.

In a first aspect of the present invention, there is provided a method of enabling a peripheral pointing device on a handheld computing device having a touchscreen and an operating system responsive to taps on the touch screen. The method comprises the steps of receiving, at the handheld device, a peripheral pointing device signal; and upon determining that the received peripheral pointing device signal is a click signal, reading a pointer tracking memory to determine a pointer location and providing the handheld computing device operating system with a simulated tap at the determined pointer location.

In an embodiment of the first aspect of the present invention, the method further includes the steps of: determining that the received peripheral pointing device signal is an X-Y offset signal; modifying the pointer tracking memory to update the X-Y position of the pointer; and painting a pointer on the touchscreen at a location determined in accordance with the pointer tracking memory. In a further embodiment of the first aspect, the method includes the step of initializing the pointer tracking memory to a predetermined location at the initialization of the handheld device, and optionally painting a pointer on the touchscreen at a location determined in accordance with the pointer tracking memory. In another embodiment, the method further includes executing an application upon determining that the received peripheral pointing device signal is a non-primary click signal. In a further embodiment, the method includes toggling a power state of the handheld device between sleep mode and active mode upon determining that the received peripheral pointing device is a non-primary click signal. In another embodiment, the peripheral pointing device is selected from a list including a mouse, a joystick, a trackball, a mouse emulation device, an assistive input device, a headpointer, a mouth joystick and a camera tracker.

In a second aspect of the present invention, there is provided a handheld device having a touchscreen and an operating system responsive to taps at a plurality of locations on the touchscreen. The handheld device comprises a pointer tracking memory, a pointer display engine and a peripheral pointing device interface. The pointer tracking memory stores the location of a pointer. The pointer display engine controls the touchscreen to display a pointer at the location stored in the pointer tracking memory. The peripheral pointing device interface receives peripheral pointing device signals, updates the pointer tracking memory when the received peripheral pointing device signals are movement signal, and passes the operating system a soft simulated tap on the touchscreen at the location stored in the pointer tracking memory when the received peripheral pointing device signals are click signals.

In embodiments of the second aspect of the present invention, the movement signal is an X-Y movement signal. In other embodiments, the peripheral pointing device interface includes a mouse emulator interface for connecting to a mouse emulator to receive the pointing device signals, wherein the mouse emulator is selected from a list including a mouse, a joystick, a trackball, a mouse emulation device, an assistive input device, a headpointer, a mouth joystick and a camera tracker, or where the mouse emulator interface includes means to connect to a mouse emulator integrated with the handheld device.

In a third aspect of the present invention, there is provided a handheld device-to-pointing device adapter for connecting a handheld computing device, having a touchscreen and an operating system responsive to taps at a plurality of locations on the touchscreen, to a pointing device. The adapter comprises a pointing device interface, a handheld device interface and a controller. The pointing device interface connects to the pointing device and receives input signals from it. The handheld device interface connects to the handheld computing device and transmits pointing device signals over the connection. The controller receives the input signals from the pointing device interface and controls the hand held device interface to transmit pointing device signals determined in accordance with the received input signals.

In an embodiment of the third aspect of the present invention, the controller includes means to control the handheld device interface to transmit an X-Y movement signal as the pointing device signal when the input signal is indicative of pointing device movement and to transmit a click signal as the pointing device signal when the input signal is indicative of a click of a button on the pointing device. In another embodiment, the controller includes means to control the handheld device interface to transmit a power toggle signal to the handheld computing device when the input signal is indicative of a click of a button on the pointing device. In a further embodiment, the pointing device interface includes a physical connector interface for connecting to the pointing device, the interface selected from a list including a PS/2 connector, an RS-232 serial connector, a universal serial bus connector, and infrared connector, a Bluetooth transceiver and a radio frequency connector, while the handheld device interface includes a physical connector interface for connecting to the handheld computing device, the interface selected from a list including an RS-232 serial connector, a universal serial bus connector, an infrared connector, a Bluetooth transceiver and a radio frequency connector. In further embodiments, adapter further includes a power supply interface for receiving power from a power supply and for providing power to the controller, the handheld device interface and the pointer device interface, optionally the handheld device interface includes power supplying means for providing power to the handheld computer device over a connector interface and the pointing device interface includes power supplying means for providing power to the pointing device over a connector interface.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a diagram illustrating a system of the present invention having a wired adapter;

FIG. 2 is a diagram illustrating a system of the present invention having a hybrid wired/wireless adapter;

FIG. 3 is a diagram illustrating a system of the present invention having a wired adapter integrated in a synchronization cradle;

FIG. 4 is a diagram illustrating a system of the present invention having a wireless adapter integrated in a synchronization cradle;

FIG. 5 is a flowchart illustrating a method of the present invention; and

FIG. 6 is a block diagram illustrating a system of the present invention.

### DETAILED DESCRIPTION

Generally, the present invention provides a method and system for enabling a pointing device in a user interface designed for touchscreen interaction.

As previously described, limited form factor computing platforms, such as palm top and other handheld computing devices, are designed around a primary pointer interface. In the case of devices running Microsoft's Pocket PC operating system, or the Palm OS, the primary pointer interface is a touchscreen. In a touchscreen-based interface, a user identifies an application from a displayed list and then taps the section of the screen corresponding to the application name, or its iconic representation. Typically, tapping is performed with a stylus to permit finer selection areas than would be possible if the tapping was done with a finger. The tapping action selects the application and the operating system then executes the application. When interacting with a menu system, the user either clicks on a menu, or executes a stroke sequence to activate the menu. With a menu displayed, the user can click on one of the options from the menu to either activate a dialog box or to display a subsidiary menu.

Applications designed for the touchscreen interface are designed to receive input from the operating system corresponding to user tapping. Additionally, in some implementations, a user can drag a stylus across a section of text to highlight text. The touchscreen interface is dependent upon user tapping or manipulation of a stylus. These actions are essential to the operation of the device. However, these actions may be difficult of impossible for disabled users, thus rendering the handheld device inaccessible.

To facilitate accessibility of handheld devices to disabled individuals, the present invention provides a mechanism for alternate pointing devices to be used with handheld devices in such a manner that existing legacy applications are supported without requiring operating system or application modification. The invention provides an interface between a standard pointing device, such as a trackball or a mouse. Signals from the pointing device are provided to the handheld device, and are processed to simulate user manipulation of the touchscreen.

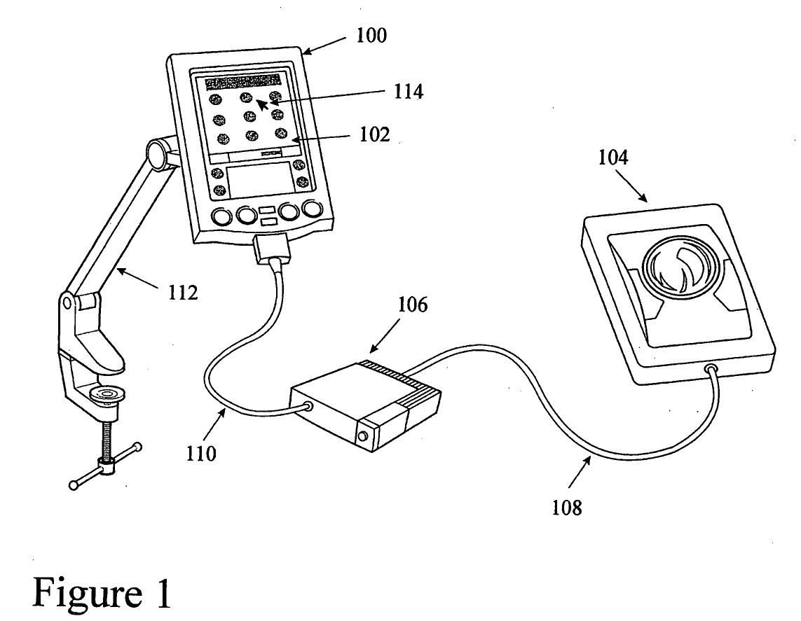

FIG. 1 illustrates an exemplary embodiment of the present invention. Handheld device 100 has a display 102 and is connected to an alternate pointing device 104 by adapter 106. Adapter 106 and pointing device 104 are connected by cable 108 that can be a standard serial cable (RS-232), a universal serial bus (USB) cable, a PS/2 style connector cable, or another such connection interface cable. The adapter 106 is connected to the device 100 by cable 110, which connects to the synchronization port of the handheld device. This connection can make use of serial or USB connections. The handheld device 100 is optionally supported by arm 112 when mounted on a wheelchair. Device 100 executes an application that receives pointing device signals from adapter 106 corresponding to actions taken with pointing device 104. The application initializes a graphical representation of the pointer on the handheld device display 102. In response to pointing device signals indicative of movement of the pointing device, referred to herein as X-Y movement signals, the application moves pointer 114 on screen 102. The pointer does not need to interact with any underlying applications, and serves to allow the user to visually determine what is being pointed to. When the user uses the pointing device 104 to click, adapter 106 provides an appropriate pointing device signal, a click signal, to device 100. The application running on handheld device 100 traps the incoming click signal and simulates a ‘tap’ on the screen at the present pointer location. This can be done by determining the location of the pointer by reading from a predefined register and then providing the operating system with a stylus emulation sequence that includes the simulated tap location. Because applications receive tap information from the operating system and because they do not directly interact with the displayed pointer, they do not need to be revised to support the peripheral alternate pointing device 104. The adapter 106, pointing device 104 and application are transparent to other applications, which react as if a user had tapped on the screen using a stylus.

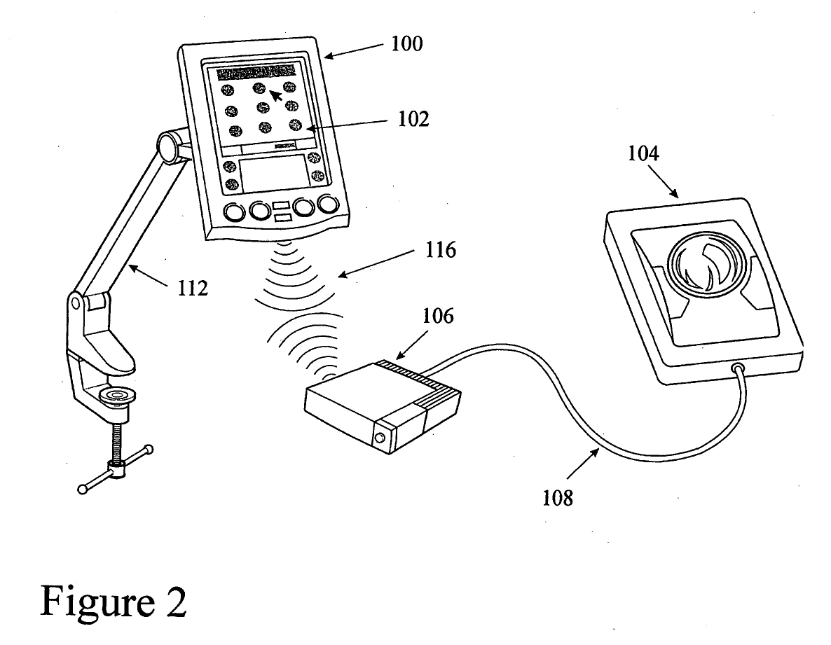

One skilled in the art will appreciate that there are a number of alterations in the physical setup of the system illustrated in FIG. 1. FIG. 2 illustrates the same use of handheld device 100 with screen 102 supported by mounting arm 112, pointing device 104 connected to adapter 106 by cable 108. However the connection between the adapter 106 and device 100 is maintained using a wireless connection, such as an infrared connection or a radio frequency (RF) connection such as a Bluetooth connection.

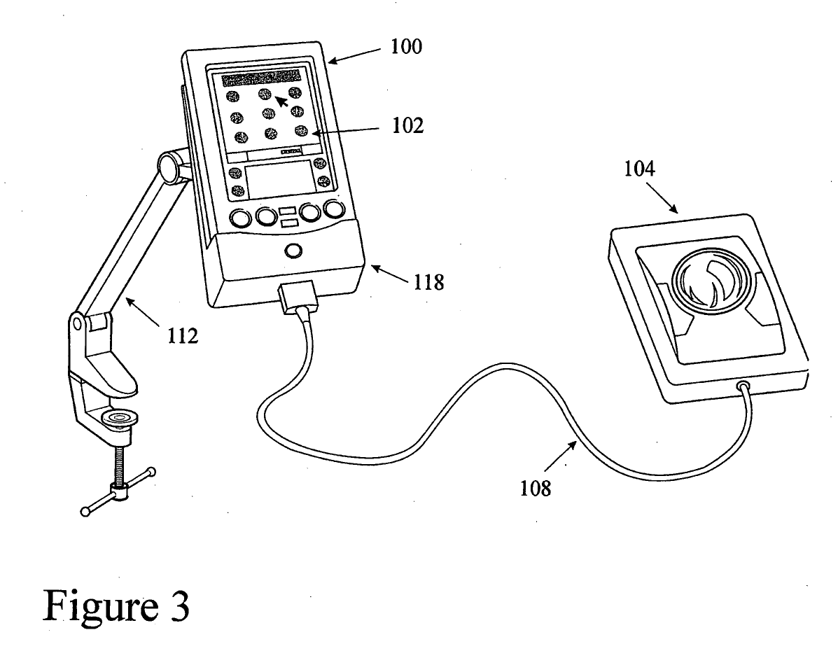

FIG. 3 illustrates a similar configuration of handheld device 100 with screen 102 supported by mounting arm 112, and pointing device 104. In this embodiment, the pointing device 104 is connected to a cradle 118 for the handheld device 100. Cradles such as cradle 118 are often used to charge handheld devices and allow them to synchronize with computers. In this embodiment, the functionality of adapter 106 is built into cradle 118.

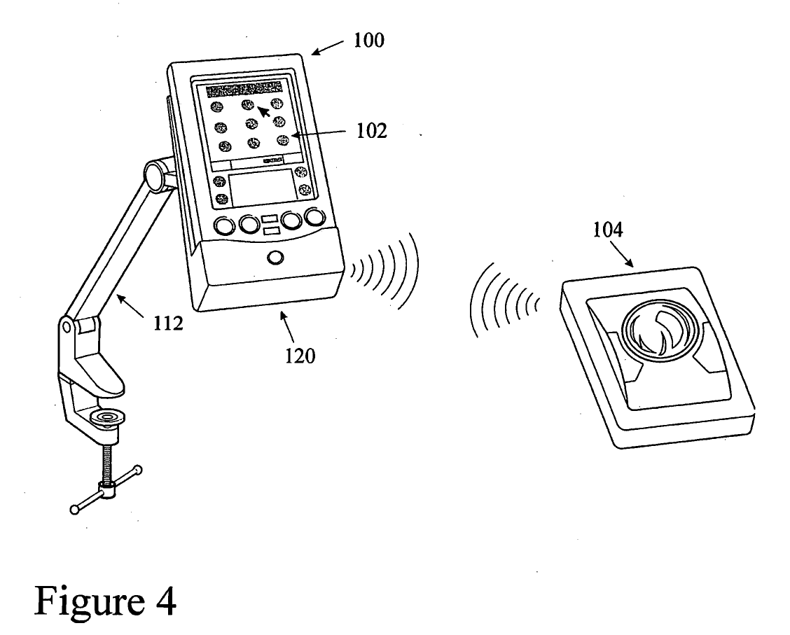

In FIG. 4, handheld device 100 with screen 102 is supported by mounting arm 112, and maintains a wireless connection to pointing device 104. The wireless connection can be maintained either through wireless enabled cradle 120 or through wireless functionality provided by handheld 100 itself. The wireless connectivity allows the pointing device 104 to connect to the rest of the system using infrared and RF connections, including Bluetooth connections.

The peripheral pointing device interface application can best be modelled as a software layer that traps the input received from the cradle interface. The received inputs are translated into changes in the X-Y position of the pointer and screen taps for each of received X-Y movement signals and click signals, respectively. Upon initialization of handheld 100, the pointer location is preferably initialized to a predetermined location, such as the center or corner of the screen, or any other desired point on the screen. The position of the pointer is preferably stored in a pointer tracking memory having a defined address. Upon receipt of any X-Y movement signal, corresponding to use of the pointing device 104, the pointer tracking memory is updated to reflect the new pointer position. Preferably a display routine reads the pointer location from the memory and paints a pointer on the screen to allow a user to visually determine where the pointer is located. When the user clicks the peripheral pointing device 104, the interface application traps the click signal and reads the pointer location from the pointer tracking memory. The interface application then passes a simulated tap action to the operating system at a location corresponding to the location of the pointer. This is referred to as soft simulating a tap.

In an alternate embodiment, operating systems often include both a press and a release action for a tap. When a user presses on a button, but does not release, an application can highlight the button, but only act, when the user releases, or moves the stylus from the screen. In this embodiment, moving the pointer over the button has the effect of both positioning and pressing the stylus into the screen. Only when the user clicks the pointing device button is the release signal provided to the operating system. This allows a user to highlight the button that will be selected if the button is clicked.

In another embodiment, the application maps the press and release actions of a tap to click and click-release actions of the buttons of peripheral pointing device 104. This allows the operating system to allow a user to hold a button down and move the pointer to allow for selection of blocks of text that would otherwise be achieved by dragging the stylus across the screen.

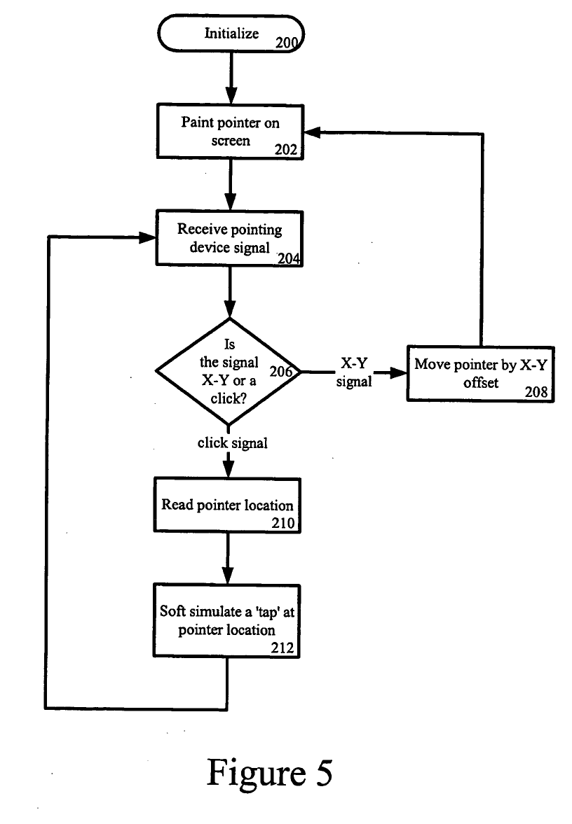

FIG. 5 provides a flow chart illustrating a method of the present invention. In step 200 the initialization of the interface application initializes a pointer tracking memory to an X-Y co-ordinate, such as (0,0). In step 202, the pointer is painted on the screen at a location determined by the pointer tracking memory. This step can be put in a loop so that when an application is launched, or repaints the screen, the pointer will not disappear from the screen. In step 204, the interface application receives a signal from the pointing device. This signal can be received directly in the case of a wireless connection such as a Bluetooth connection, or through the adapter illustrated in the earlier figures. In step 206, the interface application determines the nature of the received pointing device signal. The pointing device signal is typically either an X-Y movement signal or a click signal. If in step 206 it is determined that the received pointing device signal is an X-Y signal, the pointer location is moved by the X-Y offset corresponding to the X-Y signal. By treating the X-Y signal as an offset, the pointer tracker memory can be updated to reflect a new position using simple addition. The process then proceeds back to step 202 with the repainting of the pointer on the screen at the updated position. If, in step 206, it is determined that the pointing device signal is a click signal, the process proceeds to step 210 where the pointer location is read from memory. The reading of the pointer tracking memory allows the application to determine the present location of the pointer. In step 212, the application soft simulates a tap at the read pointer location.

The soft simulation provides the operating system with the co-ordinates of a user tap. This simulated tap is processed by the operating system using the same routines that would be used for an actual tap. The processed tap is passed to the active application, which reacts as determined by its standard routines.

In further embodiments, additional functionality of handheld devices can be controlled through the use of the peripheral pointing device. Many peripheral pointing devices, such as pointing device 104, have more than one button with which a click can be generated. The signal generated in accordance with the non-primary buttons can be directly mapped to commands. This would allow a secondary button to be used to launch a preselected application, or to perform a pre-recorded sequence of activities (a macro). One skilled in the art will appreciate that any number of buttons can mapped to macros or commands, including the primary button. In one embodiment, the adapter is programmed to interact with the handheld device, so that the button mapping is context sensitive. The context sensitivity allows the buttons of the peripheral pointing device to be mapped to different functions in different environments. In an application launcher environment, a secondary click can be used to launch a predetermined application, while a double primary click (two consecutive primary clicks in a set time interval) could be used to put the device into a sleep mode. Variations on these configurations will be apparent to one skilled in the art, and the above examples are not intended to be exhaustive, but are instead merely exemplary.

Many handheld devices have a power saving feature. This allows the device to be put into a sleep mode when the handheld device has been inactive for a predetermined period of time. Many such devices can be turned on, or awakened from the sleep mode, through commands transmitted through the external synchronization interface. This allows the device to be activated when the user begins a synchronization process. When used in conjunction with the adapter 106, the buttons of the pointing device 104 can be mapped by adapter 106 to the commands used to bring the handheld out of sleep mode. In this embodiment, the adapter 106 provides logic mapping that can convert the signals generated by the pointing device 104 into other signals recognized by the handheld device.

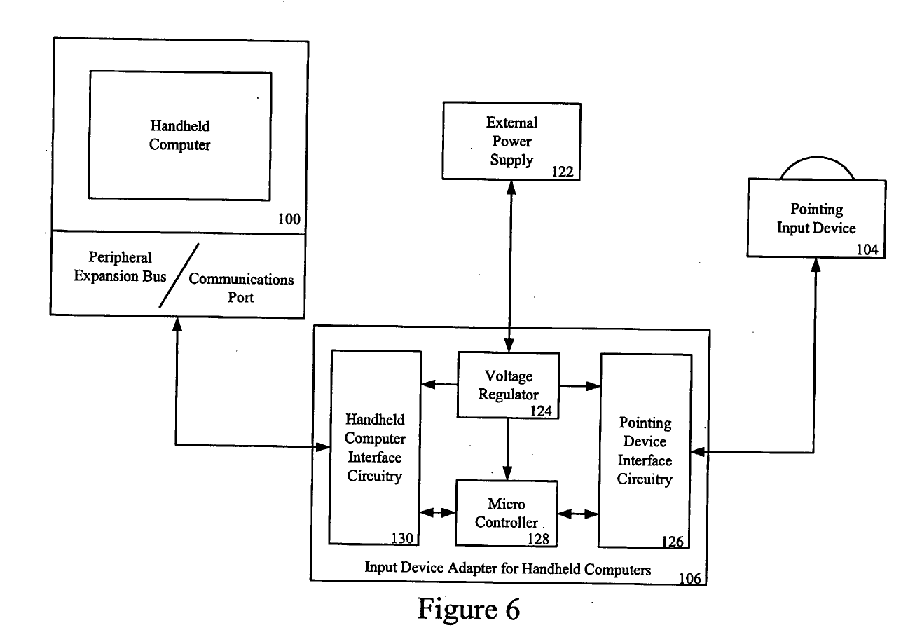

FIG. 6 illustrates the architecture of such an adapter 106. Pointing device 104 connects to handheld computer 100 through adapter 106. Adapter 106 is connected to external power supply 122. External power supply 122 feeds power to the adapter 106 through voltage regulator 124. One skilled in the art will appreciate that voltage regulator 124 is optional if the external power supply 122 can provide power cleanly enough at the required voltage levels. The voltage regulator 124 provides power to input device interface 126, microcontroller 128 and handheld computer interface circuitry 130. Interface circuitry 126 is connected to interface circuitry 130 through microcontroller 128. Microcontroller 128 has access to a memory that allows a mapping between received signals and a desired set of signals expected by the application run on handheld 100. One skilled in the art will appreciate that such a mapping can be achieved using the microcontroller 128 and a memory. The microcontroller 128 can then be programmed using standard techniques to perform lookup operations. One skilled in the art will appreciate that if adapter 106 connects to handheld device 100 through the same interface used to charge handheld 100, adapter 106 can supply handheld 100 with power via the handheld computer interface 130. Similarly, if peripheral pointing device 104 requires power, adapter 106 can supply power to the peripheral pointing device 104 through the pointing device interface 126. The use of adapter 106 as a power supply is contingent upon adapter 106 having an adequate power supply, and connecting to either handheld 100 or peripheral device 104 using a connection that permits the supply of power. Thus, when adapter 106 uses a wireless interface to communicate with either handheld 100 or pointer device 106, it is unlikely that power will be transferred.

The present invention can be implemented with as little as a software layer performing the method described with relation to FIG. 5, if the handheld device and the pointing device are able to directly communicate with each other, as they would be over a standard connection such as a Bluetooth connection. In embodiments where the adapter is used, the adapter can provide additional functionality, such as the mapping of primary or non-primary button clicks to application or event functions, and it can also supply power to the handheld device to maintain a charge.

The peripheral device can be any standard pointing device including a mouse, a trackball, a joystick, and one of several mouse emulators employed in assistive technologies for the benefit of disabled people. Mouse emulators include many devices designed specifically for the needs of disabled individuals. Head pointers, camera trackers and mouth joysticks, such as the previously mentioned Jouse, are all examples of mouse emulators employed in assistive technologies. One skilled in the art will appreciate that these lists are exemplary and not exhaustive.

In conjunction with remote control software, a port of a handheld device, such as a wireless RF or infrared port, can be used to communicate with home automation systems, allowing a disabled individual to use the peripheral pointing device to control the automation system. As an added benefit, existing applications can be executed and will benefit from the functionality of the peripheral pointing device. One skilled in the art will appreciate that the adapter can be built in to either the peripheral device or the handheld device so that a separate component is not necessary.

In addition to the above-described embodiments, the adapter and interface can be implemented as one of a Bluetooth link between Bluetooth enabled handheld and pointer devices; an external unit using a serial port, such as a universal serial port connection, to connect to both the handheld and the pointer device; a compact flash compliant adapter device designed for receiving signals from a pointer device using either wired or wireless connectivity and for providing the handheld device with the required signals; and a Secure Digital I/O compliant adapter device designed for receiving signals from a pointer device using either wired or wireless connectivity and for providing the handheld device with the required signals.

The above-described embodiments of the present invention are intended to be examples only. Alterations, modifications and variations may be effected to the particular embodiments by those of skill in the art without departing from the scope of the invention, which is defined solely by the claims appended hereto.

1. A method of enabling a peripheral pointing device on a handheld computing device having a touchscreen and an operating system responsive to taps on the touch screen, the method comprising:
receiving, at the handheld device, a peripheral pointing device signal; and
upon determining that the received peripheral pointing device signal is a click signal, reading a pointer tracking memory to determine a pointer location and providing the handheld computing device operating system with a simulated tap at the determined pointer location.

2. The method of claim 1, further including the steps of
determining that the received peripheral pointing device signal is an X-Y offset signal;
modifying the pointer tracking memory to update the X-Y position of the pointer; and
painting a pointer on the touchscreen at a location determined in accordance with the pointer tracking memory.

3. The method of claim 1, further including the step of initializing the pointer tracking memory to a predetermined location at the initialization of the handheld device.

4. The method of claim 1, further including the step of painting a pointer on the touchscreen at a location determined in accordance with the pointer tracking memory.

5. The method of claim 1, further including executing an application upon determining that the received peripheral pointing device signal is a non-primary click signal.

6. The method of claim 1, further including toggling a power state of the handheld device between sleep mode and active mode upon determining that the received peripheral pointing device is a non-primary click signal.

7. The method of claim 1 wherein the peripheral pointing device is selected from a list including a mouse, a joystick, a trackball, a mouse emulation device, an assistive input device, a headpointer, a mouth joystick and a camera tracker.

8. A handheld device having a touchscreen and an operating system responsive to taps at a plurality of locations on the touchscreen, the handheld device comprising:
a pointer tracking memory for storing the location of a pointer;
a pointer display engine for controlling the touchscreen to display a pointer at the location stored in the pointer tracking memory; and
a peripheral pointing device interface for receiving peripheral pointing device signals, for updating the pointer tracking memory when the received peripheral pointing device signals are movement signal, and for passing the operating system a soft simulated tap on the touchscreen at the location stored in the pointer tracking memory when the received peripheral pointing device signals are click signals.

9. The handheld device of claim 8 wherein the movement signal is an X-Y movement signal.

10. The handheld device of claim 8 wherein the peripheral pointing device interface includes a mouse emulator interface for connecting to a mouse emulator to receive the pointing device signals.

11. The handheld device of claim 9 wherein the mouse emulator is selected from a list including a mouse, a joystick, a trackball, a mouse emulation device, an assistive input device, a headpointer, a mouth joystick and a camera tracker.

12. The handheld device of claim 8 wherein the mouse emulator interface includes means to connect to a mouse emulator integrated with the handheld device.

13. A handheld device-to-pointing device adapter for connecting a handheld computing device, having a touchscreen and an operating system responsive to taps at a plurality of locations on the touchscreen, to a pointing device, the adapter comprising:
a pointing device interface for connecting to and receiving input signals from the pointing device;
a handheld device interface for both connecting and transmitting pointing device signals to the handheld computing device; and
a controller for receiving the input signals from the pointing device interface and for controlling the hand held device interface to transmit pointing device signals determined in accordance with the received input signals.

14. The adapter of claim 13 wherein the controller includes means to control the handheld device interface to transmit an X-Y movement signal as the pointing device signal when the input signal is indicative of pointing device movement and to transmit a click signal as the pointing device signal when the input signal is indicative of a click of a button on the pointing device.

15. The adapter of claim 13, wherein the controller includes means to control the handheld device interface to transmit a power toggle signal to the handheld computing device when the input signal is indicative of a click of a button on the pointing device.

16. The adapter of claim 13 wherein the pointing device interface includes a physical connector interface for connecting to the pointing device, the interface selected from a list including a PS/2 connector, an RS-232 serial connector, a universal serial bus connector, and infrared connector, a Bluetooth transceiver and a radio frequency connector.

17. The adapter of claim 13 wherein the handheld device interface includes a physical connector interface for connecting to the handheld computing device, the interface selected from a list including an RS-232 serial connector, a universal serial bus connector, an infrared connector, a Bluetooth transceiver and a radio frequency connector.

18. The adapter of claim 13 further including a power supply interface for receiving power from a power supply and for providing power to the controller, the handheld device interface and the pointer device interface.

19. The adapter of claim 18 wherein the handheld device interface includes power supplying means for providing power to the handheld computer device over a connector interface.

20. The adapter of claim 18 wherein the pointing device interface includes power supplying means for providing power to the pointing device over a connector interface.
